(19) United States
(12) Patent Application Publication
(10) Pub. No.: US 2006/0070753 A1
(43) Pub. Date: Apr. 6, 2006

(54) Ground improvement device

(76) Inventors: Kevin Lephart, Mequon, WI (US); J. Thomas Jones, Loveland, OH (US); Brian Moore, Georgetown, IN (US); Richard J. Cuddihe, Prospect, KY (US)

Correspondence Address: GODFREY & KAHN S.C., 780 NORTH WATER STREET, MILWAUKEE, WI, 53202, US

(21) Appl. No.: 11/250,917

(22) Filed: Oct. 14, 2005

Related U.S. Application Data
(63) Continuation-in-part of application No. 10/858,484, filed on Jun. 1, 2004.

(51) Int. Cl. A01B 33/00

(52) U.S. Cl. 172/41

(57) ABSTRACT

A ground improvement device capable of cultivating, tilling, aerating, or otherwise improving the ground. The ground improvement device has a motor and an axle with at least one tine positioned thereon. A plurality of tines may be positioned on the axle. The number, design, configuration, and location and positioning of the tines may take a variety of forms. In operation, the power source powers the axle to rotate, causing the tine to contact the ground and mix and/or redistribute the soil. A pin that is capable of performing the functions of a tine may be used to connect the axle to the motor. Specialized attachments may also be attached to the tines to improve the cultivating properties of the device.

### CROSS-REFERENCE TO RELATED APPLICATIONS

This is a continuation-in-part application that claims priority to U.S. application Ser. No. 10/858,484, filed Jun. 1, 2004, which is incorporated by reference herein to the extent it is not inconsistent with the disclosure herein.

### BACKGROUND OF THE INVENTION

This invention relates generally to an apparatus for improving the ground. In particular, the invention relates to a hand-held apparatus for cultivating, aerating, and mulching soil, fluffing up or rejuvenating compressed mulch, or scarify the top layer of soil.

Ground and soil often times must be rejuvenated in order to grow desired plants. Natural ground conditions and weather can render land difficult for farming, gardening, growing flowers, or maintaining a green lawn. The ground and soil may contain rocks, clay or other materials that hinder the growth of plants. Weather, such as rain, sun, snow, and ice, can, over a relatively short period of time, harden top soil. In addition, top soil may lack sufficient nutrients, aeration, or other properties necessary for optimal plant growth. The result is that much of the available land is unsuitable for easy use.

One method of improving ground quality is to add mulch, such as wood chips, cocoa shells, and lawn clippings, to a planting area. Plants can more easily take root in the mulch. The mulch also protects the soil and ground from weather, erosion, and foot traffic. Still further, mulch generally improves the aesthetics of a given area by presenting a uniform, manicured appearance. However, mulch, much like soil, can be negatively affected by the weather. For example, mulch is subject to becoming compacted or faded. Compaction of mulch, either by weather or foot traffic, results in the mulch becoming interconnected and compressed into a type of “thatched roof.” Compacted mulch restricts the amount of water reaching roots located below the mulch. Faded mulch is unsightly and detracts from the well-manicured and healthy look normally associated with mulch. In addition, fungus, bacteria, insects, weeds and other organisms can grow in unattended mulch.

As such, it is highly desirable to cultivate, aerate, or redistribute ground, soil, and mulch. Many devices have been designed to facilitate improving the ground. One such device is a standard ground rake. A user runs the rake over an area, mixing the top soil or mulch with the next stratus of material. Another such device is a hoe. A user uses the hoe to overturn soil or mulch and to aerate the ground. Such devices require exertion of a large amount of effort by the users to effectively improve the ground.

Another type of device is a variation on a rake or hoe. This device, commonly known as the Garden-Weasel®, has an extended handle connected to a forked end. A series of blades are connected to the forked end. The blades are able to rotate. A user runs this device over an area, thereby causing the blades to rotate. The rotatable blades allow the Garden-Weasel® to mix soil better than a standard rake or hoe. The Garden-Weasel®, however, requires significant effort to operate. This device is limited in the types of material with which it can be used. Dry or tough material cannot be easily mixed or de-thatched using the Garden-Weasel®.

Another type of device is a powered, wheeled device similar in appearance to a lawn mower. Instead of a blade, this type of device has a series of spikes. The spikes cultivate the ground as the device is wheeled around a yard or garden. Such devices are disclosed in U.S. Pat. No. 2,998,690 to Ferris, U.S. Pat. No. 3,439,747 to Kindlien et al., and U.S. Pat. No. 3,878,899 to Jones. All these types of devices are relatively large, have wheels which can hurt or destroy vegetation, and are considerably expensive to manufacture. Other types of ground improvement devices include rototillers and mini-cultivators. Such devices are disclosed in U.S. Pat. No. 4,421,176 to Tuggle et al. and U.S. Pat. No. 4,062,408 to Enters et al. These devices tend to distribute material directly behind the machine.

The current ground improvement devices suffer from certain drawbacks and limitations. Accordingly, a need exists for a ground improvement device that is easily transportable, relatively inexpensive to manufacture, relatively compact, and solves other problems associated with the existing ground improvement devices.

### SUMMARY OF THE INVENTION

The present invention provides for a ground improvement device capable of cultivating, tilling, aerating, or otherwise improving the ground. The ground improvement device is a hand-held device that preferably has a shaft with a motor and an axle. The axle has a plurality of tines positioned thereon. The motor causes the axle, and thereby the tines, to rotate. The axle rotates in a plane substantially parallel to the ground. In operation, the device is placed on the ground on an area to be improved. The power is activated, which causes the axle to rotate thereby causing the tines to dig into and improve the ground.

In one embodiment, the axle has a first set of tines and a second set of tines positioned thereon. The first set of tines may be positioned on the axle substantially perpendicular to the second set of tines. Also, the first and/or second set of tines may alternate having long and short portions extending from the axle in a given direction. Further, the first set and second set of tines may alternate on the axle.

In one embodiment, at least one pin, which can also have the functions of a tine, connects the axle to the motor.

In one embodiment, the end of at least one rod-shaped tine has a specialized attachment to improve the cultivating properties of the device.

In one embodiment, the end of at least one rod-shaped tine has a specialized triangular-shaped attachment to improve the cultivating properties of the device.

In one embodiment, the end of at least one rod-shaped tine has a specialized diamond-shaped attachment to improve the cultivating properties of the device.

### DESCRIPTION OF THE DRAWINGS

FIG. 1 is an isometric view of a ground improvement device in accordance with one embodiment of the present invention;

FIG. 2 is an isometric view of a portion of the ground improvement device of FIG. 1;

FIG. 3 is a bottom planar view of a portion of the ground improvement device of FIG. 1;

FIG. 4 is an isometric view of a portion of the ground improvement device of FIG. 1;

FIG. 5 is an isometric view of a portion of the ground improvement device in accordance with one embodiment of the present invention;

FIG. 6 is a bottom planar view of a portion of a ground improvement device of FIG. 5;

FIG. 7 is an isometric view of a portion of the ground improvement device of FIG. 5;

FIG. 8 is a partially exploded view of a portion of a ground improvement device in accordance with one embodiment of the present invention; and,

FIG. 9 is a cross-sectional view of a portion of a ground improvement device along lines 9-9 of FIG. 6;

FIG. 10 is an isometric view of a portion of the ground improvement device in accordance with one embodiment of the present invention;

FIG. 11 is an isometric view of a portion of the ground improvement device of FIG. 10;

FIG. 12 is a cross-sectional view of a portion of a ground improvement device of along lines 12-12 of FIG. 10;

FIG. 13 is an isometric view of a portion of the ground improvement device in accordance with one embodiment of the present invention;

FIG. 14 is an isometric view of a portion of the ground improvement device in accordance with one embodiment of the present invention.

### DETAILED DESCRIPTION OF THE PREFERRED EMBODIMENTS

The ground improvement device 30 of the present invention is capable of cultivating, tilling, aerating, or otherwise improving the ground. The ground improvement device 30 has a power source 34 and an axle 38 with tines 40 positioned thereon. In operation, the power source 34 powers the axle 38 causing it to rotate and when deployed on the ground, causing the tines 40 to fluff up or rejuvenate compressed mulch, scarify the top layer of soil or otherwise improve the ground.

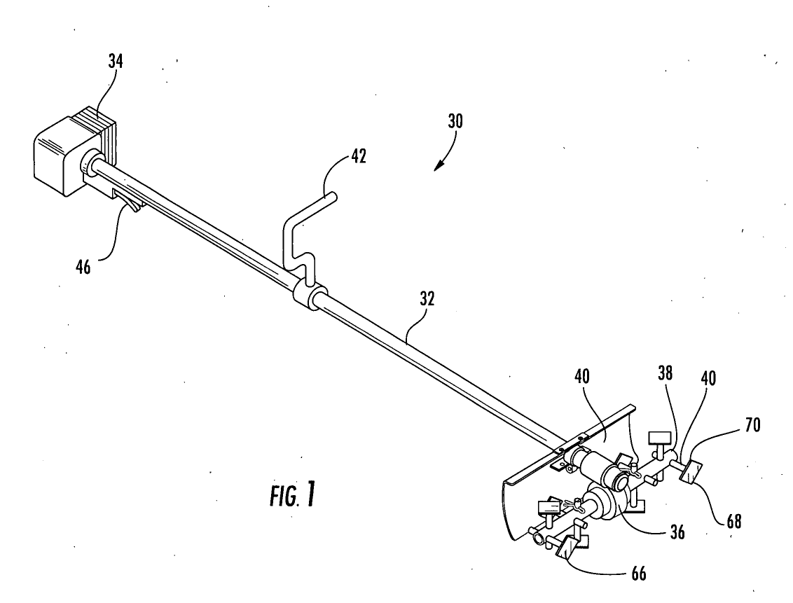

As shown in FIG. 1, the ground improvement device 30 has a shaft 32. At least one axle 38 and a power source 34 are connected to the shaft 32. The axle 38 is preferably rotatably connected to the shaft 32 via a motor 36. The motor 36 may be any device capable of rotating the axle 38 with respect to the shaft 32 or translating energy from the power source 34 into rotation of the axle 38 with respect to the shaft 32.

The axle 38 is functionally engaged with the motor 36. In one embodiment of the present invention, the axle 38 is inserted through the motor 36. In another embodiment, the axle 38 is simply attached to the motor 36 and preferably to a driver 37 of the motor 36.

In the embodiment shown in FIG. 1, the motor 36 is positioned at the end of the shaft 32. The motor 36 is powered by a power source 34 located at the other end of the shaft 32. In one embodiment, shown in FIG. 1, the power source 34 is a battery. In another embodiment, the power source is standard household power transmitted to the motor 36 via a power cord. Regardless of the power source, the operation of the motor 36 and therefore the rotation of the axle 38, is preferably controlled by a trigger 46. As shown in FIG. 1, depressing the trigger 46 results in the rotation of axle 38. Releasing the trigger 46 results in the cessation of rotation of the axle 38. Of course, the ground improvement device 30 may be equipped with a device (not shown) to prevent inadvertent operation of and/or disruption of power to the axle 38, of any suitable type now known or later developed.

Alternatively, a motor may be positioned at the top of the handle. In such case, a rod extends down the shaft 32 and engages a gear system such as a worm gear box. The motor causes the rod to rotate while the gear system translates the axial rotation of the rod into rotation of the axle 38 and thus movement of the tines 40. The motor may be any type of motor, such as an electric motor or gasoline engine.

The motor 36 preferably rotates the axle 38, at a low rate of rotations per minute (RPM). The axle 38 is rotated between about 100 to 650 RPM and most preferably between about 200 to 400 RPM. The relatively slow RPM of the axle 38 serves to break-up and evenly distribute soil, mulch, and the like, without undue disruption of the adjoining soil or throwing of the material being worked.

Preferably, the axle 38 is rotated so that the tines 40 rotate with the axle. In one embodiment, the axle 38 is a single piece attached to a driver 37. In another embodiment, the axle 38 is a plurality of parts with at least one part attached to a driver 37 on either side of the motor 36. Preferably, the axle is about 1 inch in diameter, although other diameters may be used as well. The axle 3 8 may include at least one extension attached to an end of the axle 38. The extensions may have a single tine 40 or a plurality of tines 40 positioned thereon. The tines 40 on the extension may be positioned and configured as described with respect to the tines 40 positioned on the axle 38.

The extensions allow a user to vary the functional length of the axle 38 depending on the size of an area to be improved. For example, a user may wish to use the device 30 to improve a rather large area of ground without any encumbrances such as trees or the like. Such a user could attach extensions with tines 40 to the axle 38. The extensions allow the user to improve a larger area and thus increase efficiency. Likewise, a user improving a smaller area or an area with encumbrances may remove the extensions, thereby making the device 30 more maneuverable and less likely to damage existing vegetation.

In one embodiment of the invention, at least one of the tines 40 is removably attached to the axle 38, thereby allowing tines 40 to be replaced as desired. For example, a tine 40 may be replaced if broken or worn. A tine 40 may also be replaced with a tine 40 of a different design to provide desired functionality. In one embodiment, the position of the tines 40 relative to the axle 3 8 is selectable. For example, the length of the tines 40 extending from the axle 38 may be altered as desired. Preferably, the tines 40 are inserted through the axle 38. In another embodiment, the tines 40 are permanently attached to the axle 38 by welding, adhesive, glue, bolt, screw, or the like.

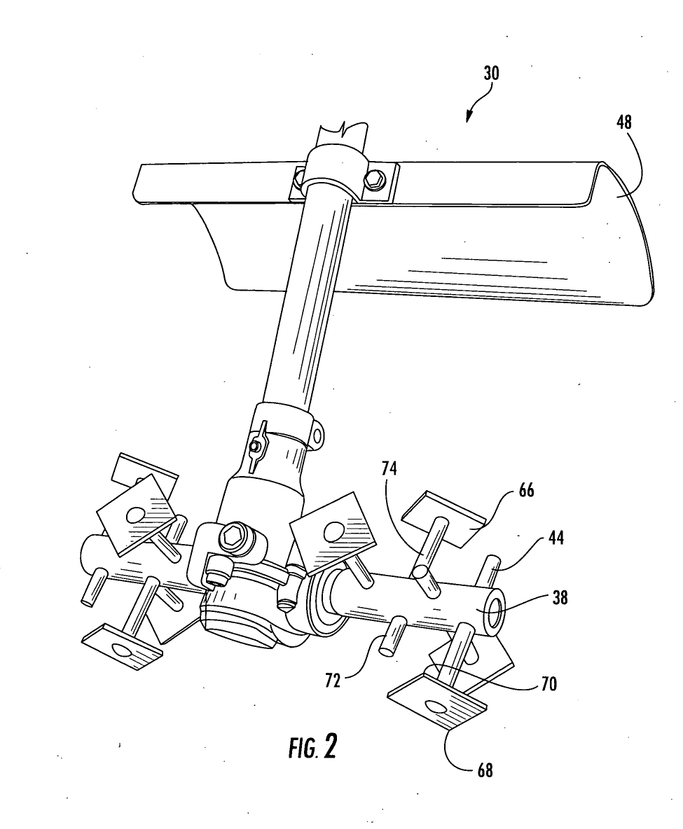

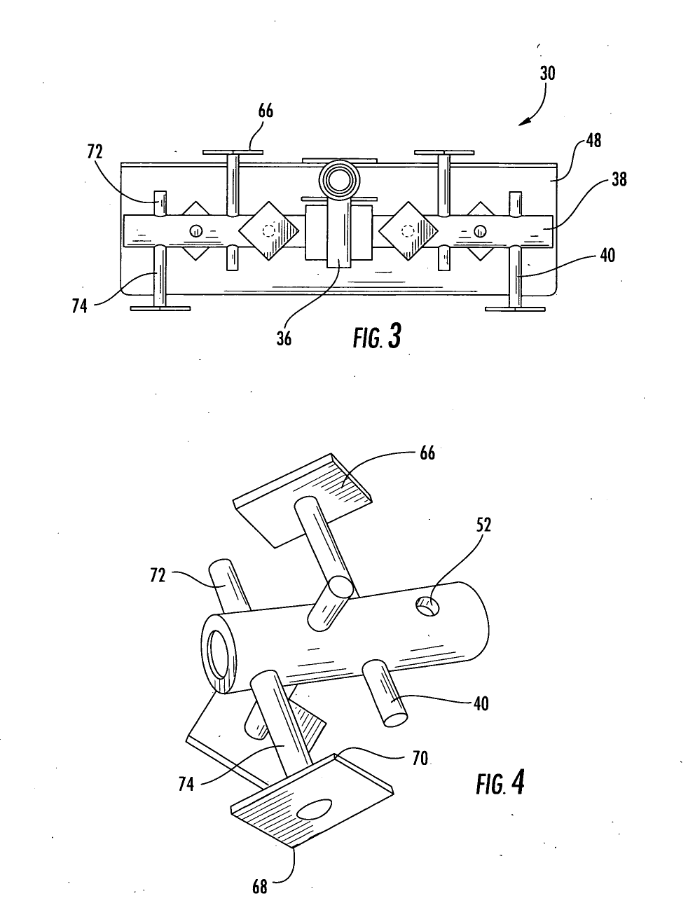

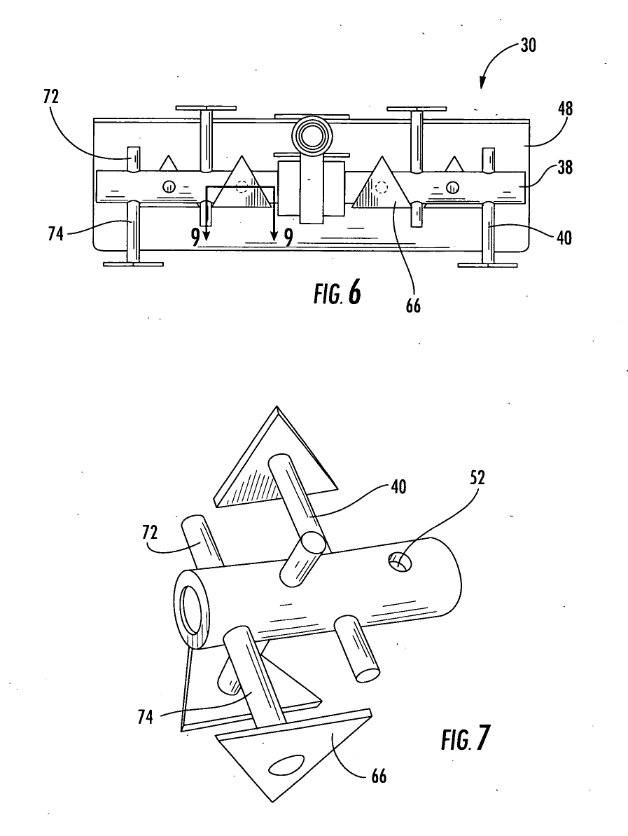

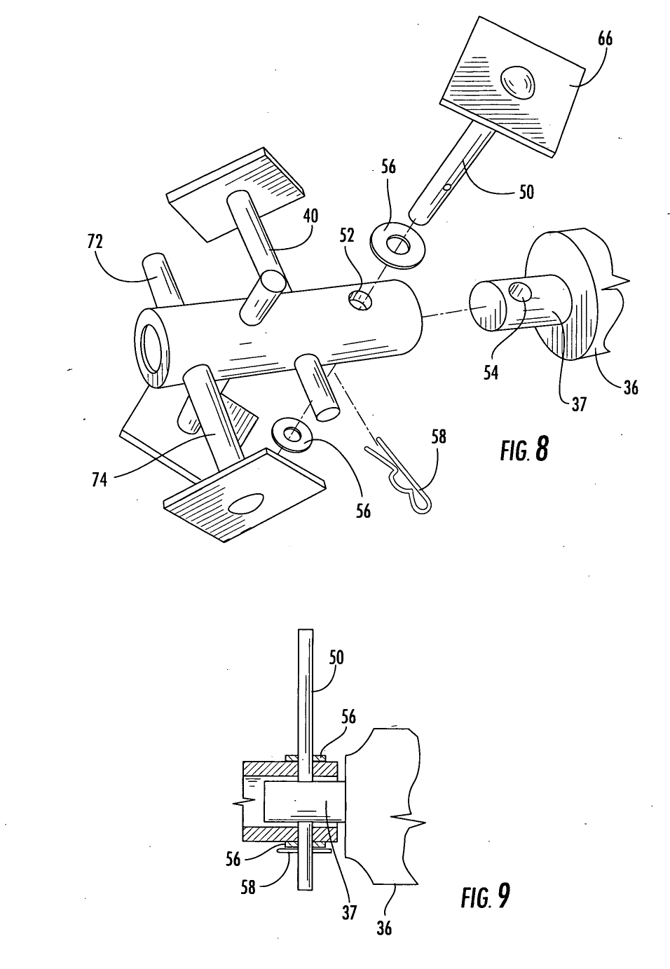

The tines 40 may have a variety of designs, shapes, and sizes. The tines 40 positioned along the axle 38 may be the same design, have different designs, or any combination thereof. Preferably, as shown in FIGS. 1-14, at least a portion of the tines 40 all have the same relative rod like shape with a round cross-section. The tines 40 may have additional structures attached thereto. For example, the tines 40 may have a blade attached thereto to cut through soil, mulch, or vegetation. The tines 40 may also be coated with any number of compositions. For example, the tines 40 may be coated with pesticide, herbicide, and/or other composition to kill, prevent, or inhibit undesirable organisms, such as aphids and weeds, from living in the ground or plants rooted therein. The tines 40 may also be coated with a composition, such as a lubricant, to facilitate passage through hardened or rocky ground. The tines 40 may also be coated with a composition, such as a rust-proofing agent or sealant, to extend the lifetime of the tines 40.

In embodiments without an extension, seven or eight tines 40 are preferably positioned on the axle 3 8 on each side of the motor 36. In embodiments utilizing an extension, each side of the motor 36 preferably has three or four tines 40 positioned on the axle 38 and three or four tines positioned on the extension.

The tines 40 may be spaced apart from one another at any distance. In one embodiment, the tines 40 are about evenly spaced along the axle 38. Preferably, the tines 40 are spaced about 0.5 to 1.0 inches, and most preferably about 0.75 inches, from the next tine with the first tine spaced about 1 inch from the motor 36.

Preferably, the ground improvement device 30 of the present invention includes certain safety and other useability features. Such features include a shield 48 positioned near the axle 38. The shield 48 helps prevent rocks, dirt, and other debris from hitting a user or from being expelled from the ground improvement device 30. The shield 48 also helps evenly redistribute loosened ground. Another feature is a handle 42 positioned on the shaft 32. The handle 42 assists the user in controlling and using the ground improvement device.

In one embodiment, the ground improvement device 30 is hand-held like a powered trimming device. In another embodiment, the ground improvement device 30 is equipped with at least one wheel and at least partially rests on the wheel when in use.

In one embodiment of the invention, at least one pin 50 is used to attach at least a portion of the axle 38 to the motor 36. In this embodiment, the pin 50 is inserted into a first bore 52 in the axle 38, through a bore 54 in the driver 37 and through a second bore in axle 38. The pin 50 is of sufficient length so that it can also perform the functions of a tine 40. The pin can be fastened by any number of means to prevent movement and adequately attach the axle 38 to the motor 36. For example, the pin 50 can be held in place by at least one fastener, such as a bolt, nut 56, screw, clamp 58, ring fastener, snap fastener, or the like in any of other embodiments without departing from the scope and spirit of the invention, or any combination of these fasteners. Additionally, the pin 50 can be held in place by welding, by using an adhesive or by interference fit with the bores of the axle 38 and driver 37.

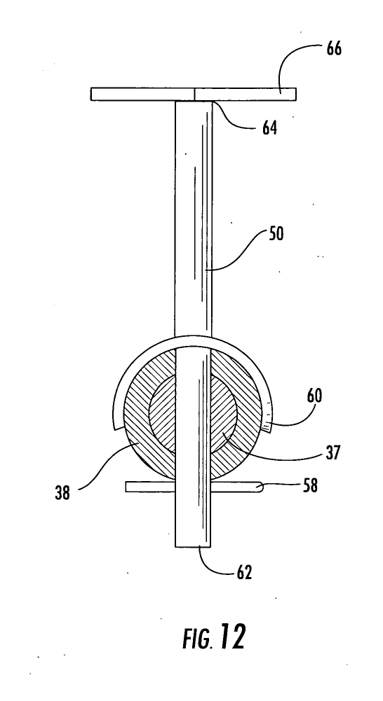

In one preferred embodiment, the pin 50 is held in place using a curved saddle-shaped fastener 60. As demonstrated in FIG. 11, the saddle-shaped fastener 60 is attached to the pin 50 and located between a first end 62 and second end 64 of the pin 50. The saddle-shaped fastener 60 can be attached in any number of ways, including by welding, using an adhesive or by at least one fastener, including but not limited to a bolt, nut, screw, clamp, ring fastener, snap fastener or the like. The pin 50 can also be made so that the saddle-shaped fastener 60 is made integrally with the pin during manufacturing of the pin 50. The saddle-shaped fastener 60 is partially curved so that the saddle-shaped fastener 60 mates with the axle 38 when the device 30 is assembled.

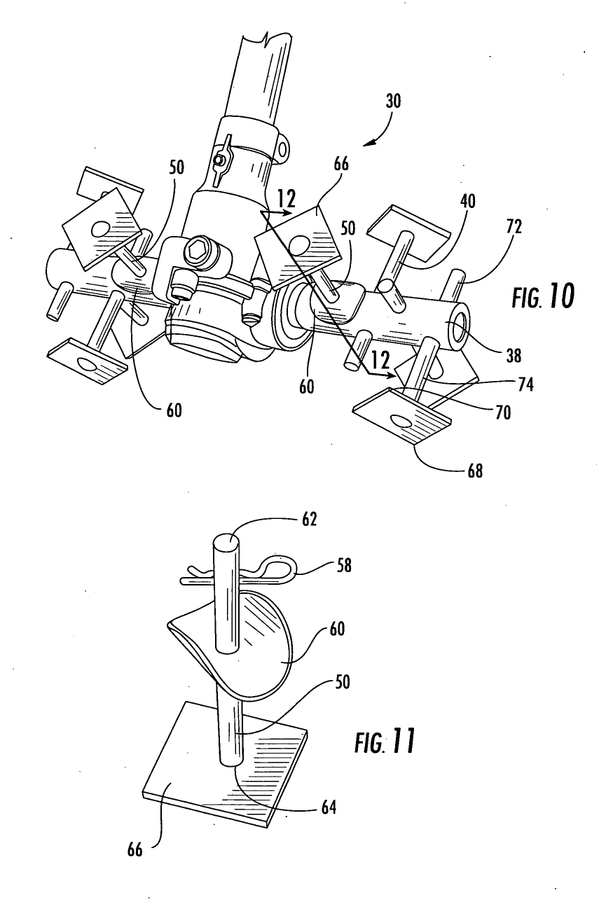

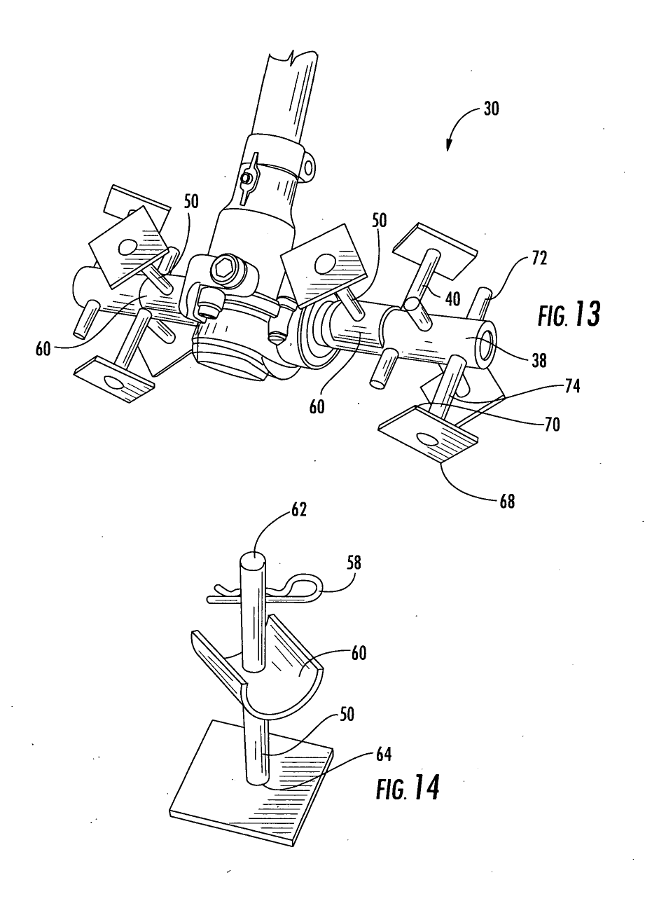

In this embodiment, the first end 62.of the pin 50 is inserted into a first bore 52 in the axle 38, through a bore 54 in the driver 37 and out a second bore in axle 38. The partially curved design of the saddle-shaped fastener 60 mates with a surface on the axle 38, prevents the further insertion of the pin 50 and also prevents the pin 50 from rotating about its longitudinal axis within the bores 52, 54. As demonstrated in FIG. 12, the saddle-shaped fastener 60 surrounds a portion of the axle 38 and preferably, extends beyond the mid-line portion of the axle 38. The saddle-shaped fastener 60 can have a variety of shapes and sizes as long as it lateral dimension is larger than the bores 52, 54. For example, as shown by FIGS. 10 and 11, the saddle-shaped fastener 60 can have curved edges or, as shown in FIGS. 13 and 14, the saddle-shaped fastener 60 can be formed with right angle corners.

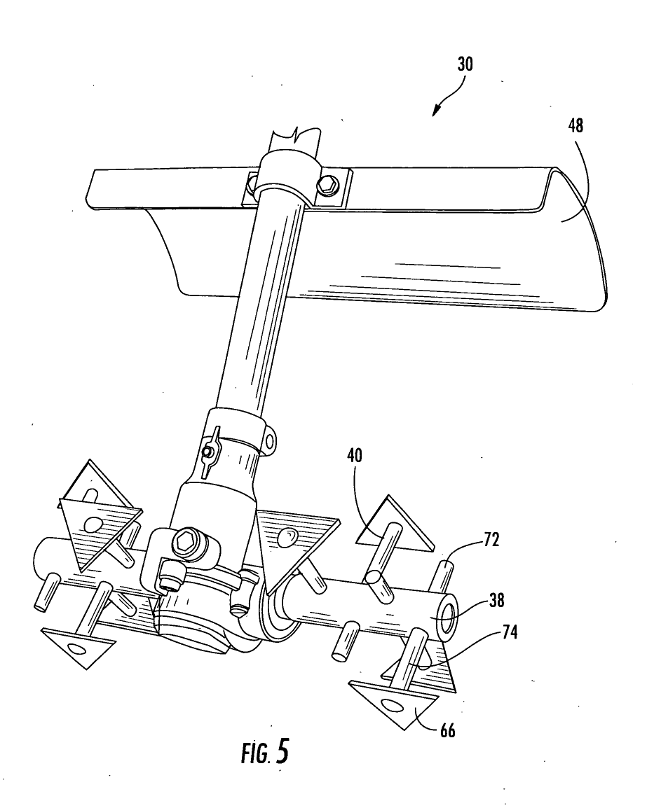

In another embodiment of the invention, the end of at least one rod-shaped tine 40 has a specialized attachment to improve the cultivating properties of the device 30. For example an attachment 66 can be attached to the end of at least one tine 40 to improve the cultivating properties of the device 30 and better handle weeds that may be found in the soil. The attachment 66 may be attached to the tine 40 in any one of numerous ways. For example, in one embodiment, the attachment 66 may be made integrally with the tine 40. In another embodiment, the attachment 66 may be welded to the tine 40. In yet another the attachment 66 is removably attached to the tine 40, thereby allowing the attachment to be replaced as desired. For example, an attachment 66 may be replaced if broken or worn. An attachment 66 may also be replaced with an attachment of a different design to provide desired functionality. The attachments 66 may have a variety of shapes and sizes. For example, as shown in FIGS. 5-7 the attachments 66 may be triangular-shaped.

As shown in FIGS. 1-4, in one embodiment, the end of at least one rod-shaped tine has a specialized diamond-shaped attachment 66 to improve the cultivating properties of the device 30. If the first tip 68 of the diamond-shaped attachment 66 is worn down, the second tip 70 of the diamond-shaped attachment 66 can be utilized. In one embodiment of the invention, the diamond-shaped attachment 66 can be rotated so that the second tip 70 of the diamond-shaped attachment 66 that was not making first contact with the soil or mulch is now the tip that is making first contact with the soil or mulch.

In one embodiment of the invention, the device 30 is equipped with diamond-shaped attachments 66 that are permanently affixed to the tines 40. The tines 40 are attached to a two-piece axle 38 that is separated by the motor 36. Each piece of the axle 38 can be removably detached from the motor 36. Preferably, each axle 38 piece is attached to the motor 36 by a pin 50 that can also be used as a tine 40. When the pins 50 are removed, the axle 38 can be separated from the motor 30. In this embodiment, the axle 38 pieces may be interchanged when the first tips 68 that are making first contact with the ground become worn. When the axle 38 pieces are interchanged, the second tips 70 of the diamond-shaped attachments 66 that were not making first contact with the ground are now positioned to make first contact with the ground.

When attachments 66 are included, the anti-rotational effects of the saddle-shaped fasteners 60 become particularly apparent, because without that anti-rotational effect, the pin 50 and attachment 66 would be free to turn different surfaces to the ground, and the cultivation effect would be reduced.

Preferably, the tines 40 positioned along the axle 38 alternate in alignment so that each tine 40 is substantially perpendicular to the next tine 40. In one embodiment, the tines 40 are inserted through the axle 38 and extend about the same amount on either side of the axle 38. Preferably, however, the tines 40 extend further on one side of the axle 38 so that at least one tine 40 has a short portion 72 and a long portion 74. The position of the tines 40 alternate so that a long portion 74 of one tine 40 is positioned next to the short portion 72 of another tine 40. Preferably, the attachment 66 is located on the long portion 74 of the tine 40.

Although the invention has been described with reference to specific embodiments, it will be understood by those skilled in the art that various changes may be made without departing from the spirit or scope of the invention. Various examples of such changes have been given in the foregoing description. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the ground improvement device discussed herein may be implemented in a variety of embodiments, and that the foregoing discussion of certain of these embodiments does not necessarily represent a complete description of all possible embodiments.

Additionally, benefits, other advantages, and solutions to the problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

I claim:

1. A hand-held ground improvement device comprising:
a power source;
a motor connected to the power source, at least one axle having a plurality of tines positioned thereon, and at least one pin connecting the axle to the motor, the pin extending through a first bore located in the axle, a bore located in the motor and out a second bore located in the axle in a direction radial to the axle, wherein said axle lies in a plane substantially parallel to the ground when the device engages the ground and wherein said axle is rotated so as to selectively bring said plurality of tines into contact with the ground on a periodic basis.

2. The ground improvement device of claim 1 wherein the pin is capable of coming into contact with the ground when the device is being operated.

3. The ground improvement device of claim 1 wherein the pin is held in place by at least one fastener with a lateral dimension larger than the diameter of said bores.

4. The ground improvement device of claim 1 wherein the pin is held in place by a clamp.

5. The ground improvement device of claim 1 wherein the pin is held in place by interference fit.

6. The ground improvement device of claim 1 wherein the pin comprises a first end and second end;
a fastener is located between said first and second ends, wherein said fastener is at least partially curved to mate with a portion of the axle.

7. A hand-held ground improvement device comprising:
a power source;
a motor connected to the power source; and,
at least one axle rotatably engaged by the motor, the axle having a plurality of tines positioned thereon, wherein said axle lies in a plane substantially parallel to the ground when the device engages the ground and wherein said axle is rotated so as to selectively bring each of said plurality of tines into contact with the ground on a periodic basis, wherein the tines have a first end that is attached to the axle and a second end that first comes into contact with the ground;
an attachment attached to the second end of at least one tine and capable of coming into contact with the ground.

8. The ground improvement device of claim 7 wherein the attachment is detachable from the tine.

9. The ground improvement device of claim 7 wherein the attachment can be rotated when the attachment is above-ground.

10. The ground improvement device of claim 7 wherein the attachment is triangular shaped.

11. The ground improvement device of claim 7 wherein the attachment is diamond shaped.

12. The ground improvement device of claim 111 wherein at least a portion of the axle can be detached from and re-attached to the motor.

13. The ground improvement device of claim 12 wherein at least one portion of the axle on either end of the motor can be removably detached from the motor and re-attached in a different orientation.

14. The ground improvement device of claim 7 wherein at least a portion of the axle can be removably detached and re-attached to the motor.

15. The ground improvement device of claim 7 further comprising at least one pin that extends through a first bore located in the axle, a bore located in the motor and out a second bore located in the axle in a direction radial to the axis of the axle so as to secure said axle to said motor.

16. The ground improvement device of claim 15 wherein the pin can come into contact with the ground when the device is being operated.

17. The ground improvement device of claim 7 further comprising a shield positioned on the shaft.

18. The ground improvement device of claim 7 wherein at least one tine is positioned on the axle at an angle relative to another tine.

19. The ground improvement device of claim 18 wherein at least one time is positioned on the axle at an angle substantially perpendicular to another tine.

20. The ground improvement device of claim 19 wherein each tine is positioned on the axle at an angle substantially perpendicular to a next tine.

21. The ground improvement device of claim 7 wherein at least one tine is positioned on the axle so that the tine has a short portion and a long portion such that the short portion extends in one direction from the axle and a long portion extends in an opposite direction from the axle.

22. The ground improvement device of claim 21 wherein an attachment is located on the long portion of at least one tine.
